(19) United States
(12) Patent Application Publication
(10) Pub. No.: US 2017/0329211 A1
(43) Pub. Date: Nov. 16, 2017

(54) Laser Projection Light

(71) Applicant: Tseng-Lu Chien, Walnut, CA (US)

(72) Inventor: Tseng-Lu Chien, Walnut, CA (US)

(21) Appl. No.: 15/170,071

(22) Filed: Jun. 1, 2016

Related U.S. Application Data
(63) Continuation-in-part of application No. 14/844,314, filed on Sep. 3, 2015.
Application No. 14/844,314 is a continuation of application No. 12/938,564, filed on Nov. 3, 2010, now Pat. No. 9,239,513.
Application No. 12/938,564 is a continuation-in-part of application No. 12/886,832, filed on Sep. 21, 2010.
Application No. 12/886,832 is a continuation-in-part of application No. 12/624,621, filed on Nov. 24, 2009, now Pat. No. 8,303,150.
Application No. 12/624,621 is a continuation-in-part of application No. 14/280,865, filed on May 19, 2014, now Pat. No. 9,581,299.
Application No. 14/280,865 is a continuation-in-part of application No. 14/503,647, filed on Oct. 1, 2014, now Pat. No. 9,719,654.
Application No. 14/503,647 is a continuation of application No. 14/023,889, filed on Sep. 11, 2013.

(51) Int. Cl. G03B 21/20; F21V 23/04; F21V 23/06; F21L 4/00; F21Y 101/00; F21Y 2115/30; F21Y 2115/10

(52) U.S. Cl. CPC G03B 21/20; G03B 21/2086; F21V 23/0471; F21L 4/00; F21V 23/06; F21Y 2115/30; F21Y 2115/10; F21Y 2101/00

(57) ABSTRACT

The laser projection light may be an AC powered laser projection light or a DC powered battery operated unit, and may also incorporate LED light or other light source device to that provides an LED or other light device illumination or other function in addition to the laser projection function in case people do not want to see the laser projection light performance and wish to switch off the laser beam. The laser light is garden light, or part of light string, laser project bulb, laser night light has its parts & accessories to offer wide area for plurality lighted image, array, geometric matrix image for desired power or wattage. Optional, A laser projection light has safety device to prevent people from directly looking into the laser beams to harm their eyes.

This application is a continuation-in-part of U.S. patent application Ser. No. 14/844,314 filed Sep. 3, 2015, which is a continuation of U.S. patent application Ser. No. 12/938,564, filed Nov. 3, 2010, now U.S. Pat. No. 9,239,513, each of which is incorporated herein by reference.

This application is a continuation-in-part of U.S. patent application Ser. No. 14/503,647, filed Oct. 1, 2014, which is a continuation of U.S. patent application Ser. No. 14/023,889, filed Sep. 11, 2013, each of which is incorporated herein by reference.

This application is a continuation-in-part of U.S. patent application Ser. No. 12/886,832, filed Sep. 21, 2010, which is a continuation-in-part of U.S. patent application Ser. No. 12/624,621, filed Nov. 24, 2009, now U.S. Pat. No. 8,303,150, each of which is incorporated herein by reference.

This application is a continuation-in-part of U.S. patent application Ser. No. 14/280,865, filed May 19, 2014, incorporated herein by reference.

### BACKGROUND OF THE INVENTION

This application has subject matter in common with the inventor's prior patent application Ser. Nos. 12/624,621, 12/622,100, 12/318,471, 12/318,470, 12/318,473, 12/292,153, 12/232,505, 12/232,035, 12/149,963, 12/149,964, 12/073,095, 12/073,889, 12/007,076, 12/003,691, 12/003,809, 11/806,711, 11/806,285, 11/806,284, 11/566,322, 11/527,628, 11,527,629, 11/498,874, 12/545,992, 12/806,711, 12/806,285, 12/806,284, 12/566,322, 12/527,628, 12/527,629, 12/527,631, 12/502,661, 11/498,881, 11/255,981, 11/184,771, 11/152,063, 11/094,215, 11/092,742, 11/092,741, 11/094,156. 11/094,155. 10/954,189, 10/902,123, 10/883,719, 10/883,747, 10/341,519, 12/545,992, 12/292,580, 12/710,918, 12/622/000, 12/710,561, 12/710, 12/711,456, and 12/771,003.

The above-listed prior patent applications of the inventor apply optics theory to LED lights for outdoor or indoor application and that are powered by alternating current (AC) or direct current (DC) supplied by an electric cord and plug for an outlet, or by a battery, transformer, solar cell, or other power source to create a plurality of LED light beams and illuminate close areas, or remote areas by projection of the light beams to the remote areas. The present invention may utilize a number of principles taught in the prior applications, including the provision of more than one light source, more than one function, more than one optics means, more than one projection means, super power saving circuits, and cost saving concepts.

### SUMMARY OF THE INVENTION

(1) The current invention relates to a laser projection light which has a special arrangement for preventing people from directly viewing the laser light beam and causing harm to their eyes. The current invention has a light blocking wall to prevent people from directly seeing the laser light source and sensor means to detect when people are near the laser project light and automatically turn off the laser projection light. Hence, the invention totally solves the problem of harm to people's eyes caused by direct viewing of the laser light source.

(2) The current invention also relates to a laser projection light which incorporates a laser, hologram, and/or grating optics means to cause the laser light beams to make desired geometric patterns that can be seen on desired surfaces including walls and a ceiling.

(3) The current invention further relates to a laser projection light which incorporates more than one laser, hologram, and/or grating optics means to change a related position of the said laser, hologram, or grating optics means by adjustable means, motor means, or other moving means to provide a variety or plurality of continuously changing light effects, including steady, random, chasing, fade in and fade out, and any other known lighting effects.

(4) The current invention further incorporates LED light means to cause the laser projection light to have a night light function and offer illumination for an area near the laser projection light. Sometimes, people do not like laser projection on walls or ceiling or ground, so they can turn off the laser projection light and only keep the LED night light as a normal LED night light function. Because the laser and LED power source can use very similar electric signals, the LED and laser can be arranged in one unit without any special technical difficulties.

The current invention thereby provides the following advantages (1) it protects people's eyes from direct exposure to the laser light beam, (2) creates a variety, of changeable laser light performances by incorporating more than one laser, hologram, or grating optics means and/or motor means, adjustable means, or moving means to change positions of the optics means and create eye-catching effects, and (3) incorporates an LED light source to provide one unit with two different light sources to become a very practical night light and projection light.

The current invention is a Division filing from the co-pending filing or parent filing cases as below attached drawing and details which from (#ZZZ-3) the Parent filing case U.S. Ser. No. 14/503,647 filed on Oct. 1, 2014 which is CIP Filing of (#ZZZ-2013) Parent case U.S. Ser. No. 14/023,889 filed on Sep. 11, 2013 show more details for Wide Areas projection by Laser(s) or by LED(s) or combination of the Laser(s) & LED(s).

The current invention also is Division of the Co-pending Parent filing of (#TT-10) U.S. Ser. No. 12/886,832 filed on Sep. 21, 2010 for Laser or LED project light device. See the Project near-by, middle range, far distance from one Laser(s) or-and LED(s).

The current invention also is Division of the Co-pending Parent filing of (#TT-10) U.S. Ser. No. 12/886,832 filed on Sep. 21, 2010 for Laser or LED project light device apply to the light strings can be full set of light string bulb(s) each one has project functions by laser or LED light-source or just some of desired light bulb/LED(s) and some is Laser projector unit(s) or LED project light unit(s) with desired installation or parts & accessories or built-into the preferred shape housing maybe bulb-like shape which match the other light source for the said light strings. The light strips may for seasonal light strip strings for special or seasonal days or patio/wall/fence/umbrella or any decorative or illumination purpose light strings for everyday use. While the Laser-unit/light or LED-unit/light install on the light string can have hook, frame, holder, shaped piece, curved piece to install the said laser or-and LEDs on position and let the light beam emit to the desired or random locations to have splendid, colorful, changeable, exciting light to light show to viewers. The below drawing is co-pending (#TT-10) U.S. Ser. No. 12/886,832 filed on Sep. 21, 2010 and this drawing is same and part of the co-inventor (#II-09) U.S. Ser. No. 12/624,621 now is U.S. Pat. No. 8,303,150 and (#II-1) U.S. Pat. No. 8,714,799 and (#II-2) U.S. Pat. No. 8,511,877 for LED project light device apply to the light strings and the current invention just change the LED project kits to Laser project kits so can upgrade the LED project application for all kind of light strings including the everyday and seasonal light string same as the above listed co-pending (#TT-10) and patented (#II-09) (#II-1) (#II-2). The co-pending (#TT-10) U.S. Ser. No. 12/886,832 filed on Sep. 21, 2010 has same drawing as below details construction how to do and what power source, It is appreciated all the disclosure or description or skill of the above listed mentioned co-pending, issued, Continue filing, Division filing case including but not limited for (#TT-10) (#ZZZ-3) (#QQQ-1) (#II-09) (#II-1) (#II-2) and its CIP or Division filing cases, all still fall within the current invention scope for Laser light present desired image on wider area, or remote distance, or colorful and changeable lighted patterns.

The current invention parent co-pending case (#TT-10=Laser or-and LED for all light device has project functions) (#ZZZ-3=Laser or LED for wide areas projection) (#II-09=Light string with project function) (#II-1=Light string with project function) (#II-2=light string with project function) (#QQQ-1=LED bulb has project functions) (#XX-10=Laser project light for all kind of lighting) also show the variety power source and linkable functions show as below drawing which is one of the example of these power source and one of the linkable example it is appreciated all kind of market available power source and linkable skill still fall within the parent and current filing cases that including but not limited for any AC or DC or solar power source(s) and linkable by quickly connector, plug, receiving ends and insert ends and all market available parts & kits.

The current invention also has co-pending filing (#QQQ-1) U.S. Ser. No. 14/280,865 Filed on May 19, 2014 for the LED projection Bulb which has bulb base to install on all market available bulb holder on ceiling or wall or surface or desk lamp for down or horizon or upper projection with or without the area illumination for extra functions. This can easily understand for co-pending filing drawing. The current invention for laser projection which also can have the extendable parts of the said bulb shape laser projector so can has wireless receiver install on the extendable top and overcome may existing glass or recess or surrounding walls to make bad wireless communication while the bulb shape laser projector fit into or install has the glass, or on depth inside the walls so can get the best wireless communication. The (#QQQ-1) U.S. Ser. No. 14/280,865 filed May 19, 2014 has LED projection Bulb, the current invention just change the LED light source to the laser light source all other features will be same as below claims. The (#QQQ-1) has a family filing case including (#QQQ-12) Now is U.S. Pat. No. 8,834,009 and (#QQQ-2) U.S. Ser. No. 14/289,968 May 29, 2014 filed, and (#QQQ-3) U.S. Ser. No. 14/983,993 Dec. 30, 2015 filed. It is appreciated all the above listed co-inventor co-pending, filing for CIP or Division and US patented co-pending cases all content, spirit, skill, technical, description inside each cases still should fall within the current inventions scope for concept, claim, features, construction not only cover the LED light source but also cover the current invention Laser light source because the laser light source still a point light source with preferred optics-piece including optics-lens, optics-film, laser optics piece, hologram piece, or grating film apply on the both point light source like the co-inventor earlier filing case on Feb. 7, 1995 U.S. Pat. No. 5,667,736 issued date on Sep. 16, 1997 which to teach how to make laser related optic-films and apply to the light source to get image on the surface of the optics-piece including lens or film. Now, The above listed laser project light is create array or matrix desired image on the wide areas for remote distance but still has laser light source and optics-piece to make the light show but not shown on the optic-piece surface. So the same inventor has the earliest skill and technical to make the laser project light applications.

The current invention for safety device for the below extendable portion of Bulb shape laser light unit(s) which can have motion sensor with desired distance and angle to cover certain areas so can send the warning sound or signal or light to people while they fall within the concern areas where the Laser light intensity may harm to the people eyes while people see the laser light source directly too closely. The laser light intensity/brightness is related to the distance from light source to (distance)square is common acknowledgement.

From above co-pending parent filing cases can see, the current invention for Laser light apply for (1) Night light has prongs (2) Light string at least has 2 light source one is laser project light and 2^{nd} or more light source (3) ceiling recess light has extend parts (4) Laser project Bulb has market available bulb base may has 2^{nd} or more light source (5) down light with other light source (6) Garden light has stake/pole/bar to install at garden (7) Camping light has laser project light and other light source (8) recess light for illumination has extend parts (9) torch light install on floor or ground with waterproof grade can create the wider areas with desired light function with variable, changeable, colorful has desired laser light beam projection including but not limited for chasing, random, flashing, moving effects for the image, shape image, dot-matrix image, design, geometric shape, array, lighted spots, character while incorporate with moving device such as motor, gear-set, movement, rotating device, spin device for animation to catch people eyes and decorate the housing, building, fence, walls, interior space, exterior space. The laser light application for outdoor use it is preferred meet all outdoor or even wet safety standard so can prevent from any electric shock while unit get wet or damage by UV or environment factors.

While incorporate with current invention and parent inventions with sensor or remote control to shut down the laser light source or emit the warning sound to the people while people fall within the dangerously distance, range, areas or too close to look at laser light source directly. This is other features for current invention.

Further more, the current invention also has more practically application for Laser or-and LED project light as below details discussion;

Including the:
1. Laser Project Bulb which has the wider opening same as the co-pending (#ZZZ-3) U.S. Ser. No. 14/503,647 which is CIP or Div of (#ZZZ) U.S. Ser. No. 14/023,889 and had discussed on top page. So wider opening can allow all laser beam spread out to wider angle/range. so the Laser project light has to have wider which is different with the Laser project which need a front magnify-lens or convex-lens on top or front so the LED project light only need lens-size opening so can project a colorful/clear/image or characters or cartoons or words or message on ceiling, walls, floor, ground, fence . . . .
2. The current invention use the Laser project light features to apply for
   a. Garden light which has ground stake to allow to insert into garden ground or soil as below details illustration FIG. 4
   b. Laser Project Bulb which has conductive bulb-base to connect with bulb-holder with at least one or more laser-optics piece and-or optics-piece to create expected or desired light show with special effects including lighted image array, matrix, shaped, contour shape, image, message, words as below details illustration FIG. 6A to FIG. 6G and some preferred shape of FIG. 6A-1 to FIG. 6F-1 which has E26, E27 or other conventional market available bulb-base for all purpose bulb used.
   c. Light string has (c-1) some Laser project light-unit for laser light beam performance, and-or (c-2) some LED bulb for illumination or project image, and-or (c-3) some incandescent bulbs for illumination with preferred bulb-size and shape and space between the each of bulbs which maybe combination for LED type, laser type, incandescent type or other market available light source type, see details illustration from FIG. 5 and FIG. 5A.
   d. Night Light has laser or-and LED project or its combination as the co-pending (#XX-1) U.S. Ser. No. 14/844,314 filed on Sep. 3, 2015 and parent filed case (XX-2010) U.S. Ser. No. 12/938,564 filed on Nov. 3, 2010 now is U.S. Pat. No. 9,239,513. See FIG. 1 and FIG. 2 and FIG. 3 and FIG. 4.

It is appreciated that all above discussed for co-pending for CIP or Division filing or US patented as above listed including the concept, idea, construction, features, skill should all be consider fall within the current invention claims without missed. It also appreciated all the alternative, replacement, equal functions of any above discussed skill, parts, accessory still fall within the current invention scope and spirits.

### BRIEF DESCRIPTION OF THE DRAWINGS

FIG. 1 is an isometric view of a first preferred embodiment of the invention. that provides additional protection.

FIGS. 2-1, 2-2, 2-3, 2-4 show details of the preferred embodiment of FIG. 1.

FIG. 2-5 shows laser light beam performance with respect to walls and ceiling, and protection range of the sensor means.

FIGS. 3-1, 3-2, 3-3, 3-4, 3-5, and 3-6 show a second preferred embodiment with different a shape of the laser projection light and both a laser and an LED light source in one unit.

FIG. 4 show 2^{nd} embodiment to apply laser-light for the Garden light which has the laser light source and at least one of optics-piece to create a plurality of laser beam has lighted light beams, lighted shapes, lighted matrix, lighted array, lighted image shown on the wider area for preferred distance.

FIG. 5 and FIG. 5A show 3rd embodiment to apply laser light for the all kind of conventional light-string which has some other light source for illumination and some are laser light source has at least one of optics-piece to create a plurality of laser beam has lighted light beams, lighted shapes, lighted matrix, lighted array, lighted image shown on the wider area for preferred distance so the conventional all kind of light string become not only supply illumination but also has laser light effects or-and LED project light effects.

FIG. 6A, 6B, 6C, 6D, 6E, 6F, 6G and FIG. 6A-1, 6B-1, 6C-1, 6D-1, 6E-1, 6F-1, 6G-1 show the features and concept and how to get desired laser light effects and relation with the laser optic-piece or-and optic-piece so can created desired light effects not only for Laser project light but also discuss comparison and cooperation with LED project light.

FIGS. 7A-7C, 8A-8F, and 9-32 show various light devices disclosed in other patent applications of the inventor, to which the principles of the present invention may be applied.

### DETAILED DESCRIPTION OF THE PREFERRED EMBODIMENTS

The current invention for a safety laser projection light which has light beam blocking wall and safety sensor means to prevent people from directly looking at the laser unit's strong light beams to overcome all marketplace concerns.

The current invention also provides a combination of a laser projection light and built-in LED light source that serves as a night light to supplement the laser projection light function in case people do not want to see laser light performance, so that people can turn off the laser projection light and keep the LED night light on when plugged into an outlet, thereby adding practicality to the laser projection light.

The current invention also may apply a motor means, adjustable means, time piece parts and accessories, and/or motion means to cause the at least one laser, hologram, or grating means to change relative orientation, position, and/or distance and thereby cause the light beam patterns to change or vary for an eye-catching laser beam light performance.

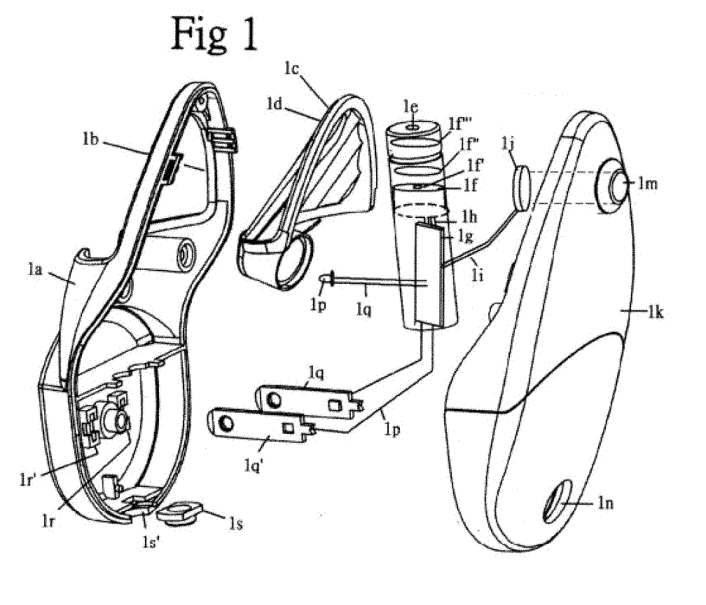

As shown in FIG. 1, the laser projection light includes a laser unit (1f), circuitry (1g), prongs (1q)(1q′), and an adjustable means (1e) to change the relative orientation or position of the laser, a hologram, a grating, or other optics means and create changeable, variable, variety, plurality of the different laser light beams performance.

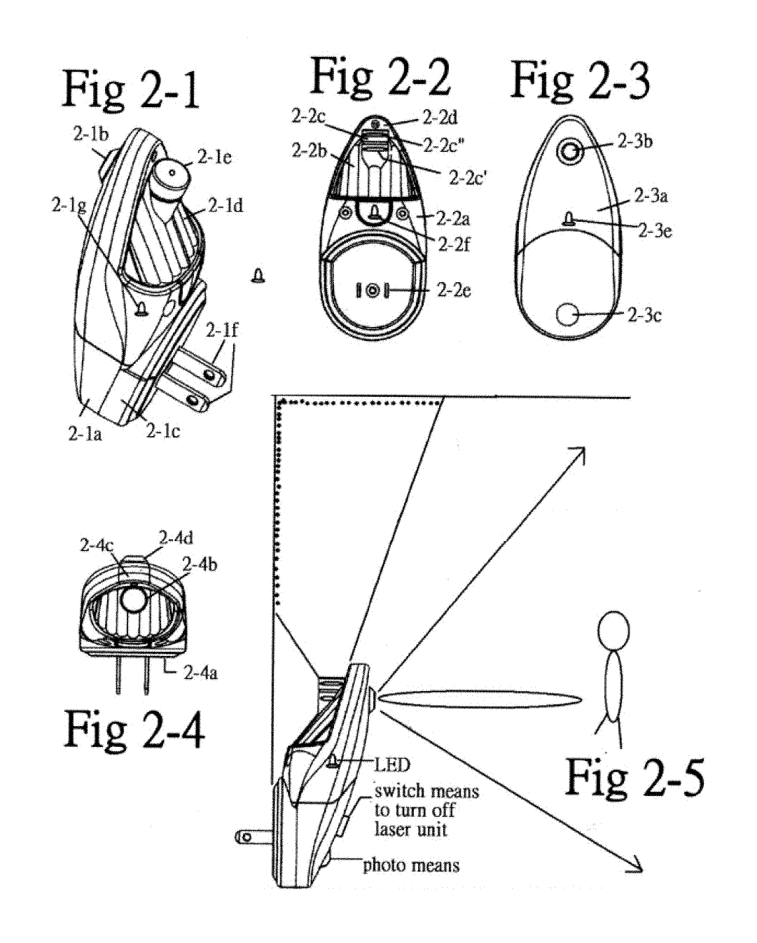

The laser unit (1f) faces upwardly while the prong means (1q)(1q′) face a rear side of the housing facing a wall outlet and a sensor 1j, lens 1m, and blocking wall (see element 2-2d in FIG. 2-2) are on the front side. The laser light beams will be blocked by the blocking wall so the laser light beams can only be emitted to a certain angle from the ceiling, which angle can be designed so people cannot directly see the light beams to harm their eyes. The safety sensor means (1j) senses people close to the projection light and stops the laser unit from emitting laser beams to provide protection that is in addition to that provided by the blocking wall.

FIGS. 2-1, 2-2, 2-3, and 2-4 show details of the preferred embodiment of FIG. 1, including a lens (2-1d) (2-2b), front housing (2-1a), back housing (2-1c) (2-2a), laser unit (2-1e) (2-4b), LED (2-1g) (2-2f) (2-3e), prong means (2-1f) (2-2c), safety sensor means (2-1b) (2-3b), blocking wall (2-2d) (2-4c) and photo sensor means (2-1b, 2-2d, 2-3b).

FIG. 2-5 shows the laser light beam performance provided the laser projection unit on walls and a ceiling. It also shows the sensor means to sense people close to the laser projection light. When people fall within the sensing range, the sensor will deliver an electric signal to circuit means to turn off the laser unit and stop it from emitting laser beams. This will prevent kids or people from directly viewing the strong light beams emitted by the laser unit, which would otherwise harm the people's eyes. The sensor range can be designed as required by the market. A preferred range is one feet, covering a vertical range of 45 degrees above and below the center and a horizontal range of 90 degrees or more to the left and right of center. In the meantime, the laser projects onto the wall into which the projection light is plugged and onto the ceiling, but part of the projection area is blocked by the blocking wall

FIGS. 3-1, 3-2, 3-3, 3-4, 3-5, and 3-6 show a second preferred embodiment with a different shape of the laser projection light but which still has a blocking wall (3-1g) (3-2s) extending on one side of the housing, a safety sensor means (3-1h) (3-2t), a top housing (3-1e) (3-2q), a lower housing (3-1d) (3-2d), an LED night light base with UL approval certification (3-1a) (3-2a), a built-in LED (3-1d′) (3-2e) that serves as a night light, a photo sensor (3-1c) (3-2c), switch means (3-1j) (3-2u) to turn off the laser projection light by manual operation, a laser unit (3-1f) (3-2m), circuit means (3-2j), conductive means (3-2i) (3-2g), a holder (3-2h), a lens (3-1d) (3-2d), prong means (3-2b), a battery compartment (3-1b) or other electric parts and accessories to cause the laser (3-1f) (3-2m) and LED (3-1d′) 93-2e) to provide two light sources in one unit. This embodiment may also include just the laser projection light without the LED. Optional added features include a hologram, laser, grating optics means and means to change the relative position and orientation of the laser unit by a motor means, adjustment means, movement means or other means to enable at least one of the optics means to change from a last position or orientation and create changeable or variable laser light effects.

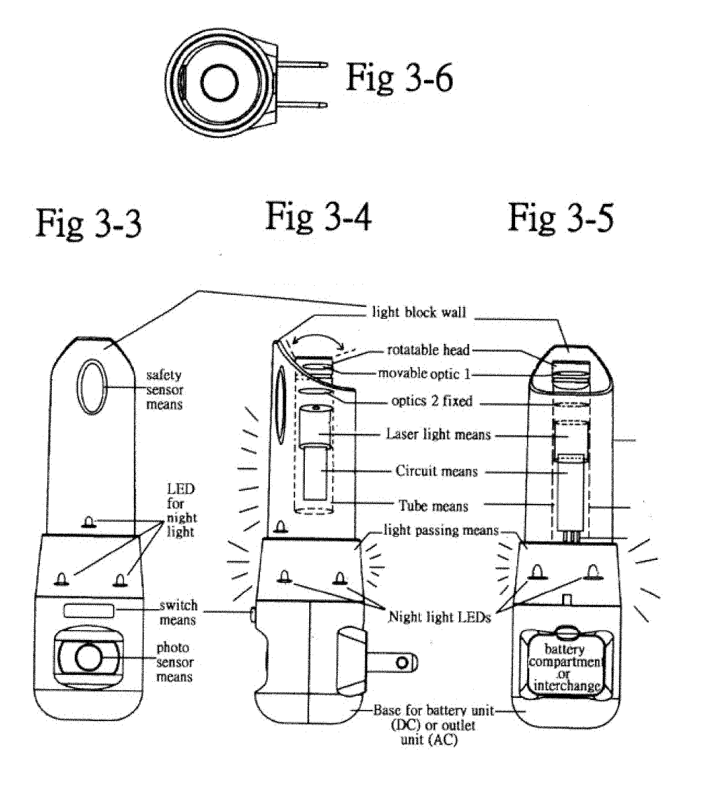

As shown in FIGS. 3-1 and 3-2, the blocking wall 3-1g,3-2s extends into the wider projection area so as to block laser beams on side of the projection area. The blocking wall 3-1g,3-2s is on the same side as the sensor 3-1h,3-2t for turning off the light device in case someone enters the sensing area. An LED 3-1d′,3-2e is also provided to provide a night light function through housing part 3-1d,3-2d even when the laser unit 3-1f,3-2n is switched off by switch 3-1c,3-2c. As usual, the night light LED may be controlled by a light sensor 3-1cj,3-2u. Power may be provided by batteries, a transformer or adaptor, or, as shown in FIG. 3-2, prongs 3-2b.

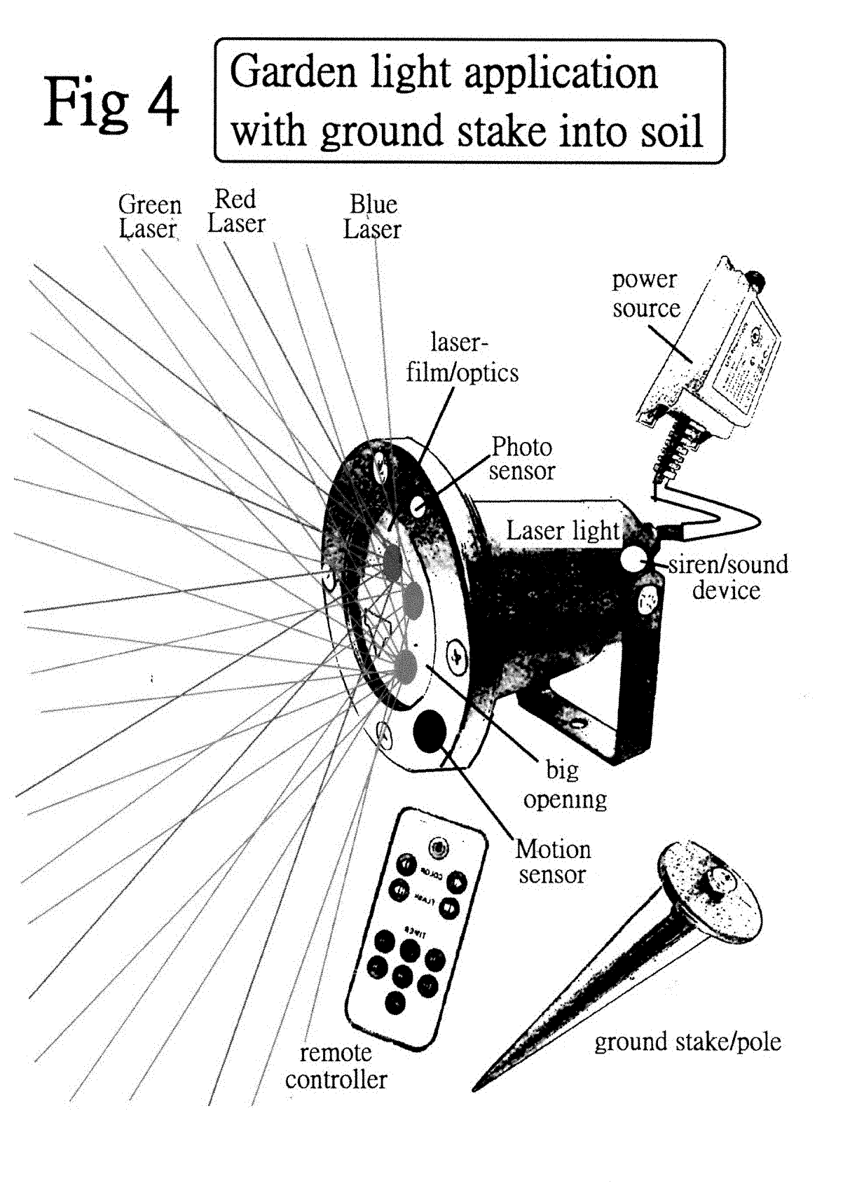

As shown in FIG. 4 which disclosure the concept to apply the laser light for garden light which has laser light source and its preferred laser optics-piece or-and other optics-piece to put into outdoor garden light which has ground stack/pole to insert into the garden ground with waterproof or water resistance or any environment grade quality for outdoor use.

The laser project garden light mainly to offer the laser light effects for building, house, home, walls, fence, garage door all wider areas with desired light effects. Which have to have a wider opening for the said Laser garden light which is same as the above listed (#ZZZ-3) The current invention is a Division filing from the co-pending filing or parent filing cases as below attached drawing and details which from (#ZZZ-3) the Parent filing case U.S. Ser. No. 14/503,647 filed on Oct. 1, 2014 which is CIP Filing of (#ZZZ-2013) Parent case U.S. Ser. No. 14/023,889 filed on Sep. 11, 2013 show more details for Wide Areas projection by Laser(s) or by LED(s) or combination of the Laser(s) & LED(s). From above discussed and illustration shown the wider opening for laser project garden light, project bulb, light string has laser project light unit(s) all same need a wider opening on the laser light emit ends so can allow Laser light beam widely spread out from the laser light beam output end(s). Also, need to incorporated the laser optics-piece including but not limited such as grating piece or hologram piece or-and to incorporate the other optics-piece including but not limited for convex-lens, diffusor-lens, random-diffusor lens, plurality different or variable thickness diffusor lens, reflective lens, refraction lens with single or multiple or plurality of different optics-focus and thickness in one piece as design or light effects required. From above discussed on (#ZZZ-3) and illustration on the background can see show many different optics-piece which also including the said cut-out, stencil, color filter, windows, opening, shaped windows or same functions or equivalent piece which the purpose is to create desired light effects and place top of the light source output end including laser light source or LED light source or other light source. These laser optic-piece or any other optics-piece mainly to make simple laser or LED or incandescent bulb to get desired light effects for certain range and distance to see the lighted pattern.

Also From the (#ZZZ-3) The current invention is a Division filing from the co-pending filing or parent filing cases as below attached drawing and details which from (#ZZZ-3) the Parent filing case U.S. Ser. No. 14/503,647 filed on Oct. 1, 2014 which is CIP Filing of (#ZZZ-2013) Parent case U.S. Ser. No. 14/023,889 filed on Sep. 11, 2013 show incorporate the moving device which including but not limited for motor, gear set, moving device, rotating device, spin device, movement or any moving kits to make the said optics-piece including laser optics-piece or other optics-piece or other cutout, plastic piece, injection piece, lens, film, slide, cutout, stencil, window, filter to moving to make the moving device. It also may incorporated with IC, timer, sensor, switch, controller, wireless controller, Bluetooth, wifi, internet, wired or wireless communication sets, zeeG wave communication or controller, power source, invertor, adaptor, transformer, USB power parts & accessories, solar module, rechargeable batteries, wind power source, chemical power source to turn on and turn off the said laser light device for pre-determined functions.

The said Laser Garden light has at least one of color of laser light source, It may be two or three color or more color and has pre-determined turn-on and turn-off timing to create one or more color lighted spot, image, shape, matrix, array for any conventional laser image effects which may be a dot matrix, linear array, seasonal signs, characters, words . . . and it may get IC help to create flashing, chasing, random, Fade-in and Fade-out, pair flashing, dot-matrix, image matrix, image array with desired time period, duty, cycle, brightness, colors . . . etc.

While incorporate with moving device to create the changeable, variable, sequential change laser beam light show has moving effects and changeable features. It also can incorporate with other light source such as super strong LED light source to create the other light effects to combine with laser light beam effects to form the alive image which may look like moving aurora effects, galaxy, solar system, waterwave, animation for all marketing available laser light show all these features as above listed all the co-pending or co-inventor all filing case after the current filing case parent filing case (#XX-2010) including the (#TT-2010) (#ZZZ-3) (#QQQ-3) (#II) (#II-1) (#II-2) family including the each family parent and child filing case. All these filing cases after 2010 filing (#XX-2010) and CIP or Division (#TT-2010) (#ZZZ-3) (#QQQ-3) (#II) (#II-1) (#II-2) family all related technical, skill, method, design, concept, construction, functions, features, parts should be still consider within the current invention scope for the current invention for (a) Garden light (b) light string (c) laser Bulb (d) Laser Night Light application and each of the current invention claims had very clear limitations for each (a) (b) (c)(d) has certain parts and accessories as below claim content.

From FIG. 4 can see the garden light has 3 color laser light source including Red color, Green color, Blue color and has the most simple laser optic-piece on front with IC or-and motor/movement device to make the multiple colors laser light beams to come out continue changeable, variable, sequential changing light effects to project the lighted dots,

Shape image, matrix, array, shapes, character, words to remote away distance to cover big and wide surface of building, house, ground, floor, fence, walls, surface, wall, residence to present desired words, image, message, geometric image on the said wide areas. The said garden light has ground stake or pole which can insert into garden ground or install on the garden floor and has the power source which may connect with 120Volt AC or get power from the invertor/transformer/adaptor or from the garden available for low-voltage power source which for the conventional low-voltage garden light. It also can powered by the solar power source, wind power source, chemical power source with its rechargeable energy storage device maybe is a rechargeable batteries. From FIG. 4 also show the wireless controller for preferred embodiment to control the light functions, brightness, color, timer, on-off even can control the sound while the said Garden light incorporated with the sound device, speaker, Radio, Bluetooth speaker or wifi speaker or other market available sound device. The said garden light also can have metal base or bracket to hold or install the said garden light on other application while the garden light housing redesign to make 360 wide opening like the said above discussed (#ZZZ-3) drawing it can fit into Camping light device so can allow people to carry while go to Camping and still has the ground stake/pole to insert into the camping campus ground for 360 degree or wide angle areas has laser light show for night time celebration or party. The camping light may has Bluetooth speaker, USB port so can rechargeable inner rechargeable battery or batteries and same time it become a Power bank to charge mobile phone, ipad, iphone while power ran out.

These application is CIP or Division for co-pending filing for (#GGG-2011) U.S. Pat. No. 8,783,936, (#GGG-1) U.S. Pat. No. 8,915,608, (#GGG-2) U.S. Pat. No. 8,9119,137, (#GGG-3) U.S. Ser. No. 14/189,062, (#GGG-1C) Ser. No. 14/548,561, (#GGG-2C) Ser. No. 14/548,620, (#GGG-3C) Ser. No. 14/643,026, (#GGG-4) Ser. No. 14/189,062, (#GGG-4C) Ser. No. 14/827,810, (#GGG-5) Ser. No. 14/839,935, (#GGG-5-1) Ser. No. 14/858,538, (#GGG-6) Ser. No. 14/834,557, (#GGG-7) Ser. No. 14/834,823, (#GGG-8) Ser. No. 14/834,613, (#GGG-9) Ser. No. 14/870,601, (#GGG-10) Ser. No. 14/951,872 family has all details discussion for the USB charging port features and method to making same.

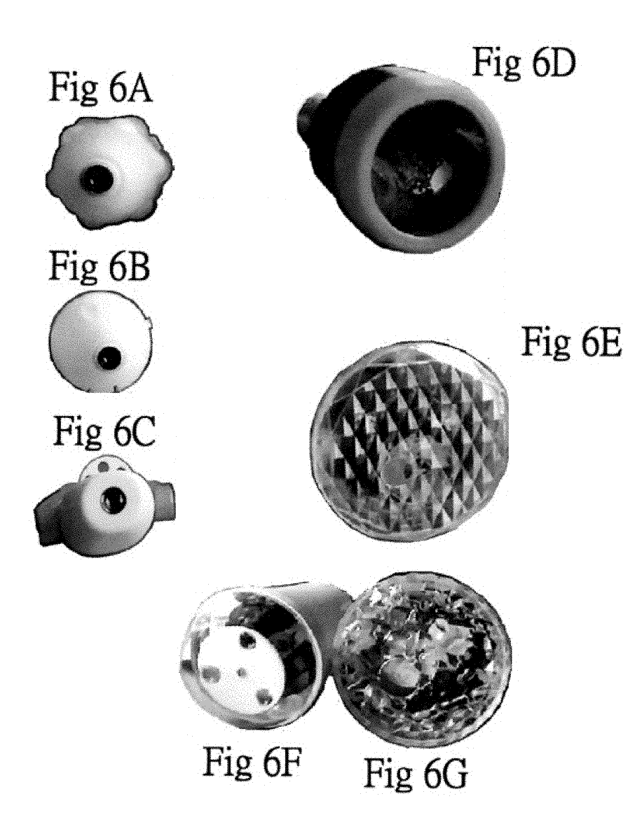

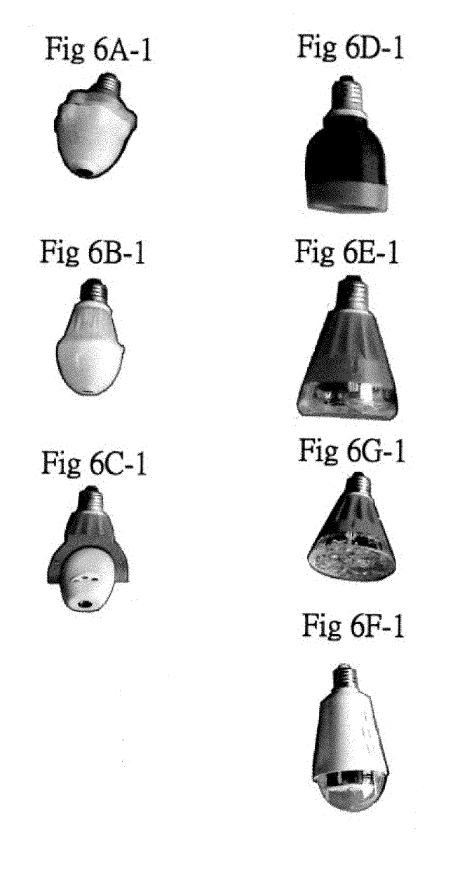

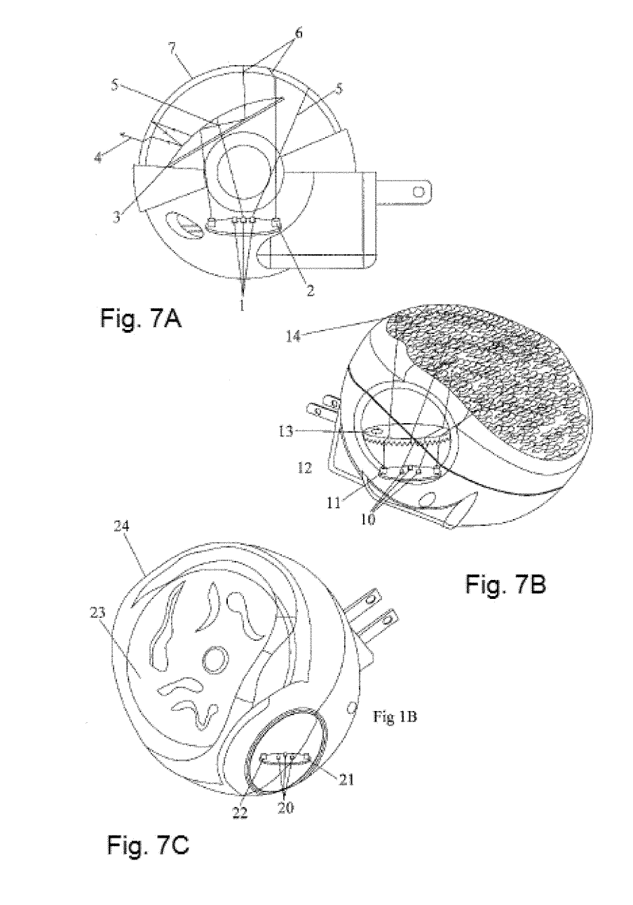

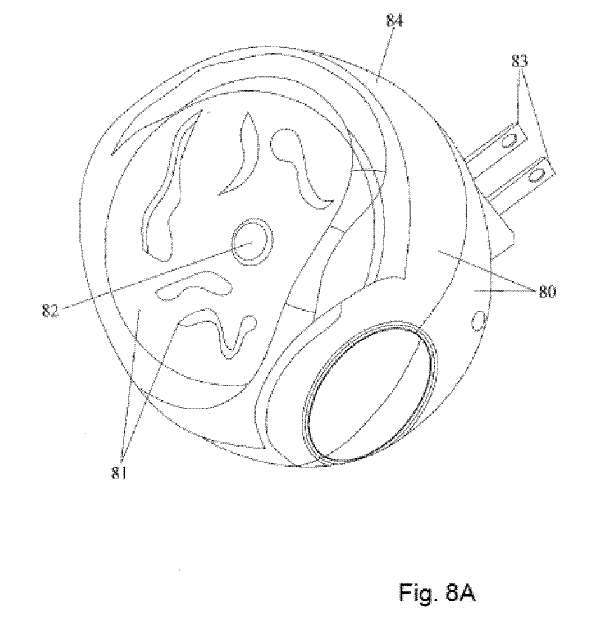

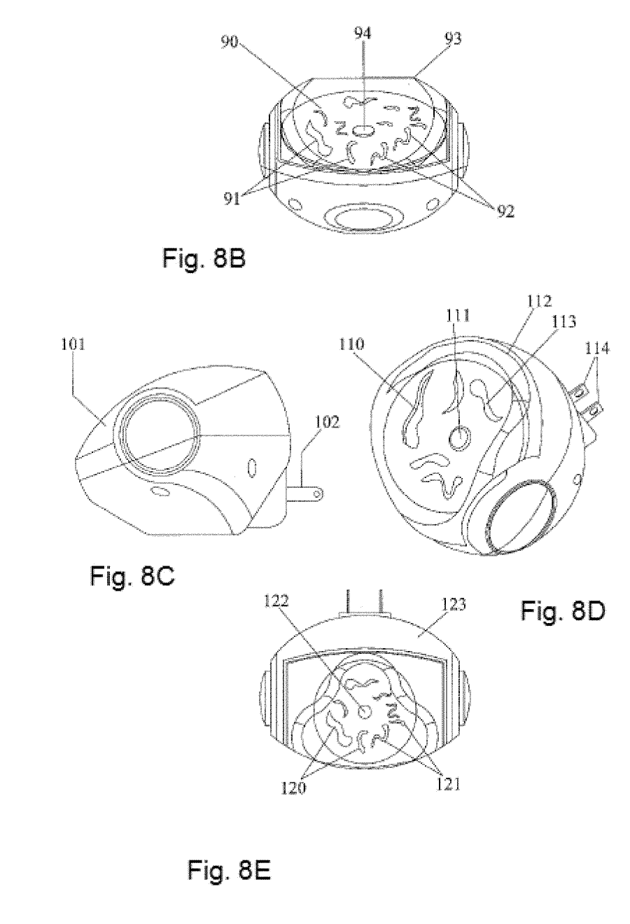

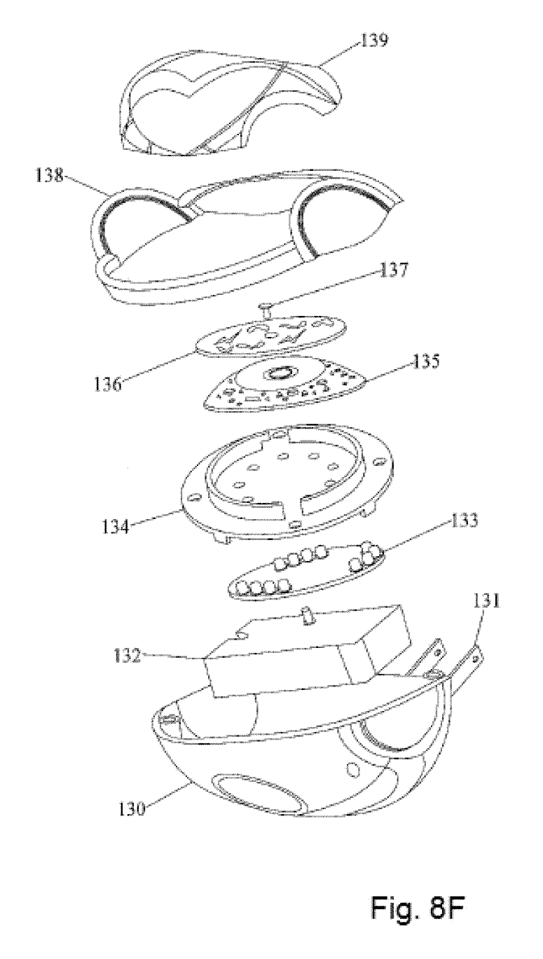

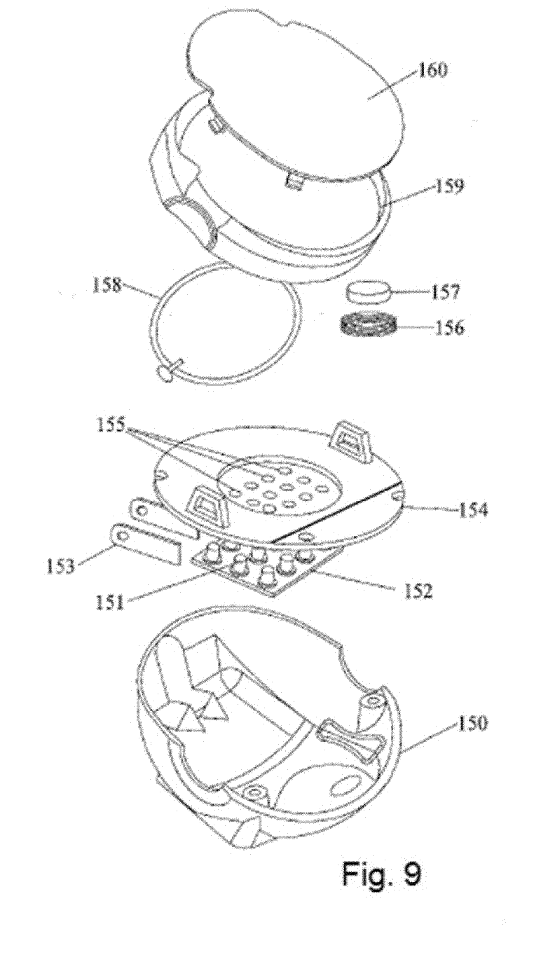

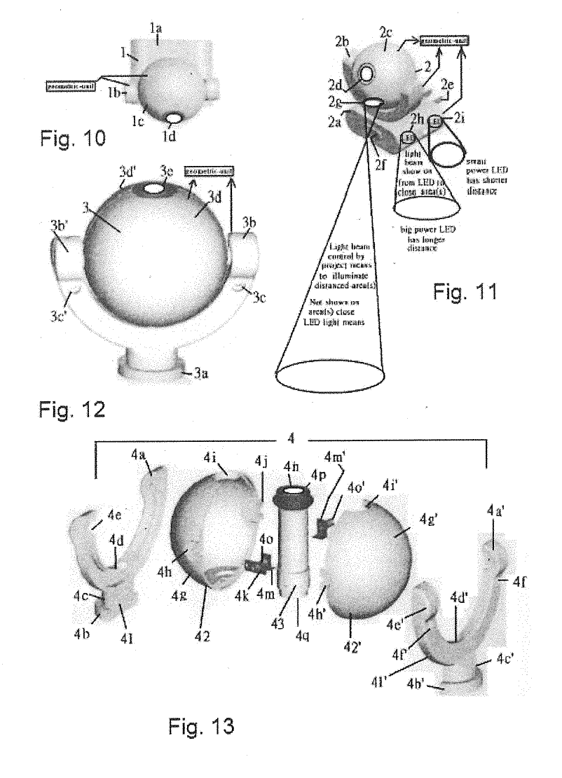

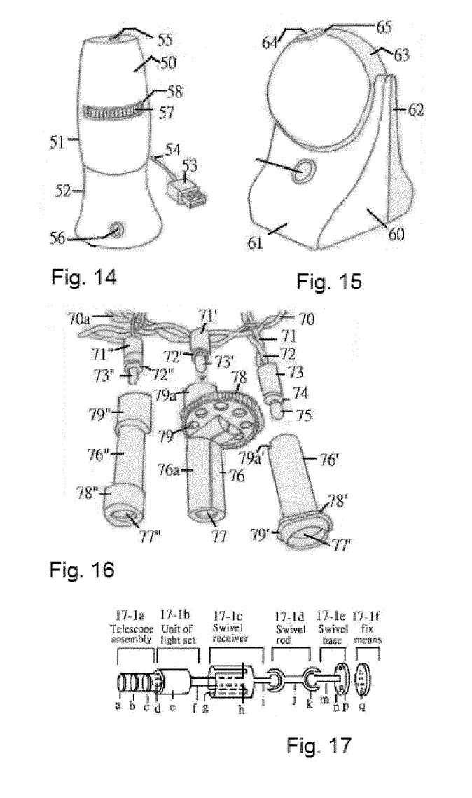

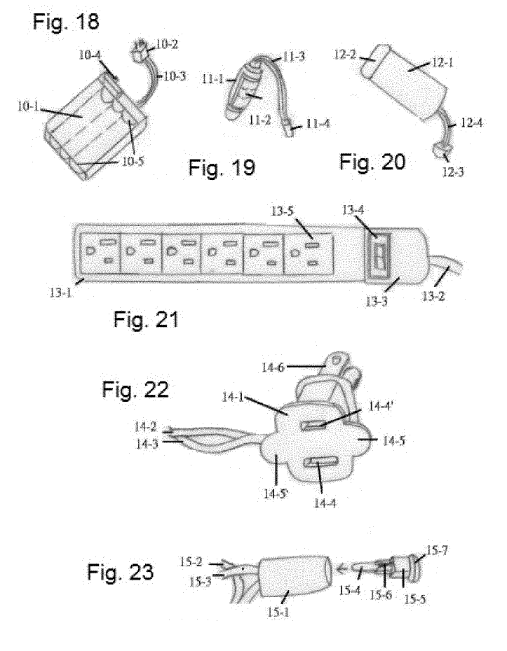

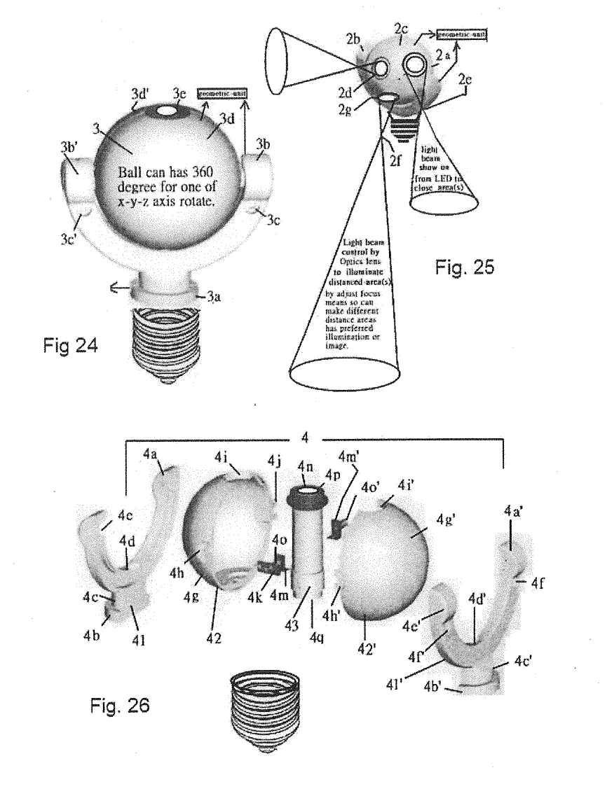

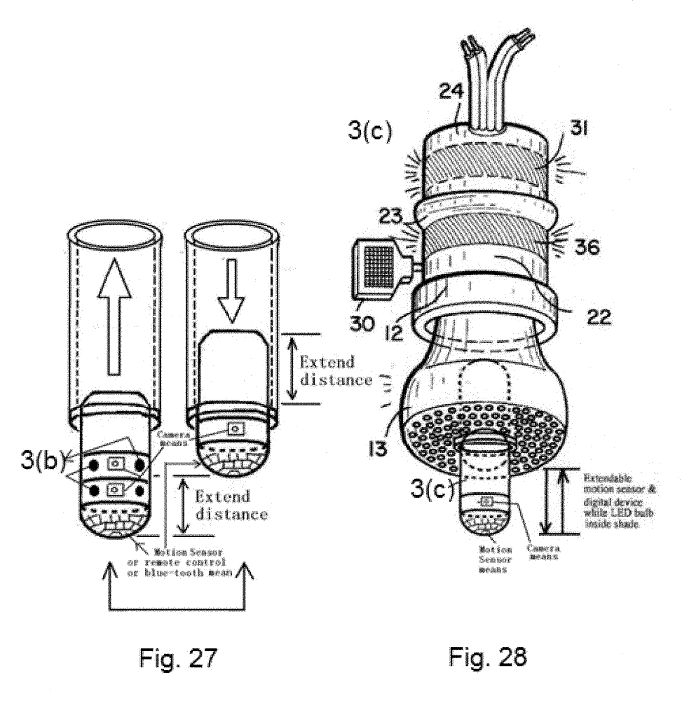

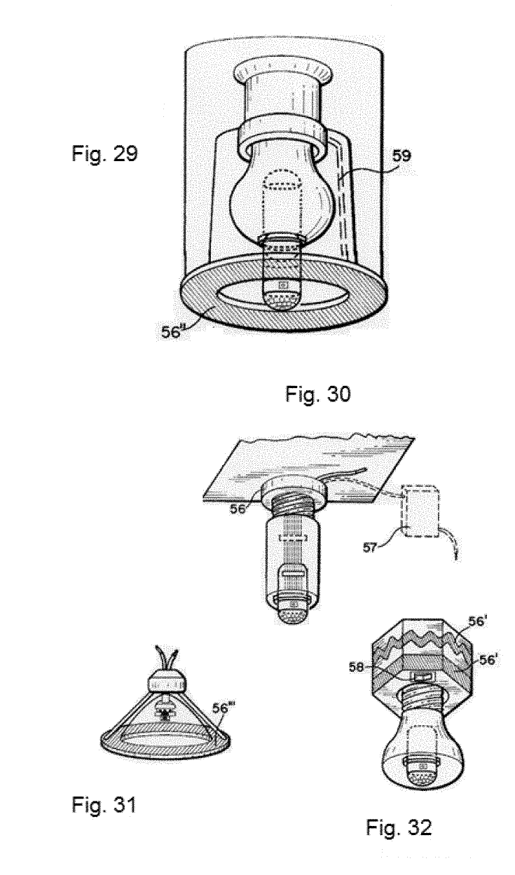

From FIG. 6A to FIG. 6G and FIG. 6A-1 to FIG. 6G-1 show the Laser project bulb for different construction. The inner parts & accessories for laser light source, laser optic-piece (grating or hologram or other laser piece), with or without motor is similar with the above discuss for FIG. 4 or the said all parent filing case and its CIP or Division co-pending cases. The Current From FIG. 6A to FIG. 6G mainly to show more optic-piece including but not limited including cutout, stencil, window (clear see though but not opening), filter, color filter, opening, plastic piece, reflective lens, refraction lens, convex lens, diffusor lens, variable thickness lens, plurality of focus lens, texture lens or all kind of plastic piece, film, injection piece, lens to increase the laser or-and LED project light performance, effects.

From FIG. 6A to FIG. 6G show the all different lens and light top opening design. Laser light have to big and wide opening so allow all the laser beams can emit to all directions as many as possible. The preferred embodiment is 180 degree or can design for over 180 degree up to 270 or smaller degree which depend on market requirement.

From FIG. 6A to FIG. 6G also show the Laser project has above discussed preferred parts and accessories inside the housing with the bulb-base which can be any type of market available type for different bulb-holder for different shape/size bulb shape for different lighting fixture used. Furthermore, the current invention show the variety preferred more than 1 optics-lens, optics-piece, optics-cover to add top of the said inner laser light parts & accessories to create more eye-catching light performance. Such as FIG. 6D just has windows, FIG. 6E has the plurality of reflective properties lens. FIG. 6F has plurality of round diffusor lens into one piece optic-cover to make inner laser light beam to become aurora effects, some other laser light is passing though from clear window which has no plurality of round diffusor lens so it only pass though inner laser-optic piece such as grating piece so can get plurality of lighted spots or matrix or array look like planets for different colors so can make like galaxy look-like effects. The FIG. 6G show the optics lens install on moving disc so can make the lighted image to moving for certain degree arc or circles on surface . . . . It maybe many many tubes and limited optic-lens which has more details description and skill on co-pending filing (#QQQ-3) U.S. Ser. No. 14/983,993 filed on Dec. 30, 2015. From FIG. 6A show the movable or tiltable LED project Bulb which can move the top level for projector away from top block means which may desklamp top metal frame or shade frame/support so the laser or LED projector Bulb can over come the block metal frame, metal shade support for desk lamp. From FIG. 6B is LED bulb for recess light or ceiling installation which is not like for Desk lamp has block metal frame or metal shade support, so no need tilt or movable along the axis to let project light beam do not block by the metal frame of metal shade support of desk lamp. From FIG. 6C show the project Bulb which has changeable slide, laser film, grating film, hologram film or other optics piece or slide, film, display piece on the roller which can use manual or automatically change so can different light effects. From FIG. 6D, FIG. 6E, FIG. 6F, FIG. 6G show all has wide opening on front of laser project bulb because need to have Bigger and wider opening so can allow all laser light beam spread out to wider areas. From FIG. 6A, FIG. 6B, FIG. 6C show the LED project Bulb which the top of the Bulb has Lens-size opening normally is as smaller as possible because it will affect the cost for the inner image-display/film/slide and inner other optic-lens such as convex lens or concave lens if had any and inner tube diameter and size. So LED project bulb top lens is as smaller as possible so can make low cost unit. So Laser and LED project bulb has major different construction but the current invention all is CIP or DIV for (#XX-10) filing and has more details can see from above listed co-pending parent filings cases.

From FIG. 6A-1 to FIG. 6G-1 show the housing shape with bulb-base to allow all Laser or LED project bulb fit into relatively Bulb-holder. The bulb shape for laser bulb need as big & wide as possible to allow all laser beam emit out. The LED project bulb top end only need have magnify lens size so it is smaller as possible to save cost. The regular LED bulb or Incandescent bulb or other light bulb for illumination purpose no need any opening because it glow for all direction as radiation light source. Not like Laser light source or LED light source belong to point light source so need laser optic-piece or other optic-piece to help to get the laser or LED narrow light beams to spread out to have desired light performance and effects.

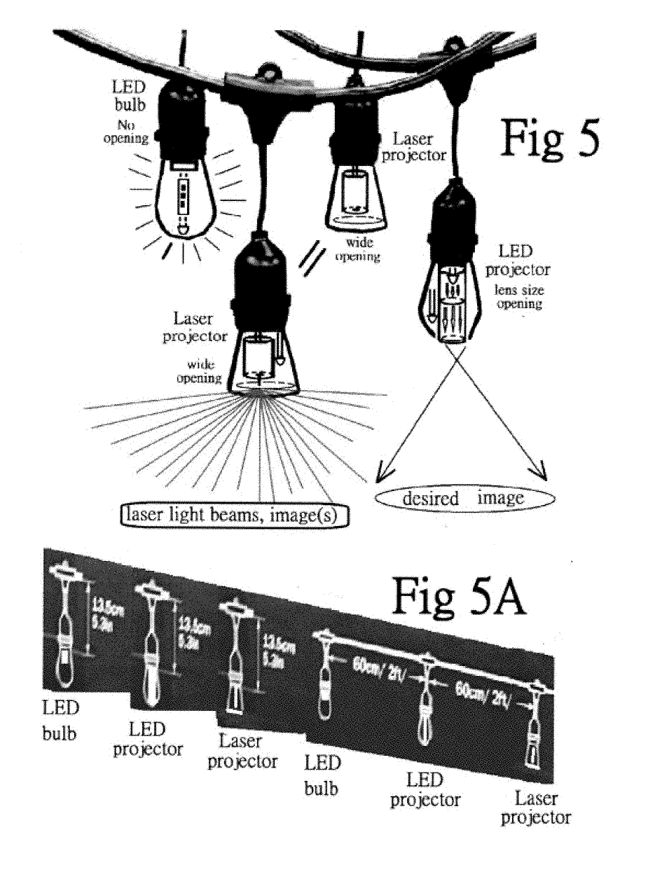

From FIG. 5 show how to apply the FIG. 6D, 6E, 6F, 6G laser project bulb and FIG. 6A, FIG. 6B, FIG. 6C laser project bulb to apply the said market all kind of light string same as co-pending (#TT-10), The co-pending case (#TT-10=Laser or-and LED for all light device has project functions) (#ZZZ-3=Laser or LED for wide areas projection) (#II-09=Light string with project function) (#II-1=Light string with project function) (#II-2=light string with project function)(#QQQ-1=LED bulb has project functions) (#XX-10=Laser project light for all kind of lighting) also show the variety power source and linkable functions show as below drawing which is one of the example of these power source and one of the linkable example it is appreciated all kind of market available power source and linkable skill still fall within the parent and current filing cases that including but not limited for any AC or DC or solar power source(s) and linkable by quickly connector, plug, receiving ends and insert ends and all market available parts & kits.

The current invention to add the laser project Bulb with desired construction into the market available all kind of light string for everyday use for patio, backyard, BBQ areas for nighttime activities or Camping campus use. The current invention use the similar of FIG. 6D, 6E, 6F, 6G for wide opening laser project Bulb has inner at least one or more of the same color or different colors laser light source and its related laser-optics piece or piece(s) with or without added other optics-piece to get desired steady or movable or changeable or variable lighted image, message, dots, shape image, contour shape, array, matrix light effects. The laser or LED project Bulb it may no need bulb-base and the laser project light or LED project light can be install within the molded base by preferable parts for the said molded light string or has the bulb-base to let the said light string can replace the illumination bulbs (incandescent bulb or LED bulb) and-or laser project Bulb and-or LED project bulbs.

Because laser or-and LED project Bulb or light is very costly so current invention preferred just use limited number of the Laser or-and LED project bulb or light for the existing illumination purpose light string including everyday or seasonal light string. For example 10 light string maybe only add 2 for laser or-and LED project bulb or light, so the cost is not dramatically too high. However, some application has very long light string in one piece such as 36 feet or 48 feet which can have more unit such as every 6 feet has one Laser or-and LED project Bulb or light unit on the whole light string. Some short items has big space between each illumination bulbs so can have whole string with laser or-and LED project bulb. The number of laser or LED project bulb or light depend on market requirement,

While the everyday light string or seasonal light string has limited number or whole light string has all laser or-and LED project bulbs or units can make a big light performance than the current only illumination purpose for these light string. Furthermore if add the laser project bulb(s) or unit(s) on the light string. The wide area will be lighted by the eye-catching, splendid, colorful, changeable, variable lighted spots, image, shaped image, words, message to increase accent and decoration the backyard, garden, patio, BBQ areas or other areas, spece people have night time or dark environment activities.

So the current invention for the FIG. 5 show the very exciting light strings for everyday light string which use incandescent or LED light source or other light source to offer illumination but also has laser light beam light effects or-and LED project light effects is the big improvement than single offer illumination single one functions light string for more value.

From the CIP or Division filing after the parent (#XX-2010) and its Child filing (#XX-1) U.S. Ser. No. 14/844,314 filed on Sep. 3, 2015 and parent filed case (XX-2010) U.S. Ser. No. 12/938,564 filed on Nov. 3, 2010 now is U.S. Pat. No. 9,239,513. See FIG. 1 and FIG. 2 and FIG. 3 and FIG. 4. And later filing cases including but not limited for co-pending case (#TT-10=Laser or-and LED for all light device has project functions) (#ZZZ-3=Laser or LED for wide areas projection) (#II-09=Light string with project function) (#II-1=Light string with project function) (#II-2=light string with project function) (#QQQ-1=LED bulb has project functions) has details discuss the said how to connect the project light or project Bulb by the clipper, holder, hook, frame, snake hose, flex-n-hold, bar, fix device, connector, snap kits to hold, fix, position, the said laser or-LED bulb or light-unit on the light string and can position the direction for the laser or LED light beams to emit to desired areas and direction. The said Laser or-and LED bulb or light-unit for the market available all kind of light string with positional kits help to let laser or-LED project light can emit to desired wide or near-by areas is the 3^{rd} application for current invention as above illustration with some examples show but not limited for all above listed co-pending case or after (#XX-10=Filed Nov. 3, 2010) all filed cases concept, idea, construction, features should be fall within the current invention scope and spirit should be missed for laser project light for (a) Garden light (b) Laser project Bulb or light unit (c) Laser project bulb or light unit for all kind of light string (d) laser project for Night light application for indoor and outdoor use.

1. The Laser project light consist of:
At least one of the safety device on the housing to prevent from laser light beam direct to emit from laser light source to people eyes while people close to project light.
At least one of the safety device arrange on housing to detect the people location and distance to the said laser projection light and turn off the laser beam or a warming sound/siren/alarm while people get into the safety range of the safety device.
The said laser project light are consist of from group combination from the parts & accessories select from housing, laser light source or unit(s), circuit, prong, battery compartment, laser optics lens, hologram optics parts, grating optics parts, adjustable parts, motor, movement parts, motion parts, conductive parts, photo sensor, switch, lens, LED, LEDs, UL listed with testament certification parts, LED or other or more light source(s), controller, ground stake, light-string hooks, light-string clipper, light-string positional kits, light-string holder, conductive base for variety of shape bulb(s), to make the Laser project light to has pre-determined laser beam light performance while the laser project light connect with power source.
The said laser light performance may selected from group combination select from flashing, chasing, random, rotating, fade in and fade out, moving, color changing, color adding, geometric light patterns show out, Dot or geometric image matrix patterns, lighted arrays, lighted image matrix for image changeable, variable, movable, sequential changing, motion picture which are available from conventional market place light effects.

2. The laser project light and LED light consist of;
At lease one LED light incorporate with laser light source or unit(s) to get the electric signal to turn on and turn off the said Laser unit(s) and-or the said LED light under pre-determined light pattern performance.
The said Laser project light is one of
(1) garden light has ground stake or pole to install on garden ground or into soil,
(2) hanging patio light or light-string with installation kit, hook, holder, clipper,
(3) laser project bulb has conductive bulb-base for variety shape of bulb,
(4) light string has at least 2 light source, one is laser light source,
(5) plug-in night light has prongs,
(6) solar power lighting has laser project light for part or whole light device.

3. A laser projection light, comprising:
a laser projection unit that includes a laser light source and means construction for projecting laser beams to a remote wide area outside said laser projection light,
wherein said light base includes circuit and connect to power components for supplying power to said laser, and
wherein said said laser projection unit projects laser beams to a remote wide area.
The said light has
(a) prong, or
(b) ground pole/sticker/stake/bar to insert into or install on the ground, or
(c) inside of a bulb-like housing to install on light string for part of light string, or
(d) conductive bulb-base and bulb-shape housing for a laser project bulb.
The said laser project light which has
(1) wired direct to AC power or low-voltage power source, or
(2) incorporate with transformer, adaptor, invertor to get power, or
(3) bulb-base connect to bulb-holder receiving end or
(4) prongs to insert into outlets
to get the laser light working voltage and current.

4. The laser light has optics parts consist of;
At least one laser source or unit(s) install within the laser light housing.
At least one installation kits to install the laser light on wall, garden, soil, light-string, ceiling of building, residence, house, patio, shop, stores where people stay.
The laser unit(s) has laser light source and at least one of grating or hologram or laser related optics piece(s) incorporated with the said laser light source(s) to create the laser light performance including multiple light spots, image, shape, colors, words, image matrix. Lighted arrays, plurality of lighted image(s).
The said laser light incorporate preferred parts & accessories may selected from group combination from power source, circuit, AC-to-DC circuit, DC-to-DC circuit, installation kits, switch, sensor, controller, remote controller, wire, wireless controller, motor, movement, transformer, adaptor, invertor, laser optics parts, 2^{nd} light source, LED(s), LED light(s) to show the pre-determined light show.
The said light show including at least one but not limited select from group functions from changeable, variable, colorful, sequential changing, fade-in and fade-out, chasing, or desired conventional market available laser light show with pre-determined light performance, duty, cycles, time period.
The said laser light is
(a) Night light has prongs
(b) Garden light has ground stake/pole to install on the garden or soil (c) Laser bulb has bulb-base to install into conventional bulb-holder
(d) Light string has some other light source(s) and some number of Light source is/are laser light has laser beam emit out.
(e) Camping light has built-in laser light source for laser light show and other light source for Illumination with or without the added functions but not limited for Bluetooth Speaker, power bank to charge device has USB related ports/

5. The laser light has optics parts as claim 4, the said laser light is a garden light and get power from (1) wire to the power source; or (2) solar device to get power from solar module and energy storage device; or (3) battery or batteries; or (4) DC power source.

6. The laser light has optics parts as claim 4, the said laser light is part of the light strings which whole light string has desired number of the said laser light source(s) or laser light kits(s) so light strings has incandescent bulb or LED bulb for illumination functions plus laser light emit the plurality of desired laser light beam out to wide areas under pre-determined light performance.

7. The laser light has optics parts as claim 4, the said laser light is part of the said LED light device so can have the LED light device for illumination functions plus the laser light to emit plurality of laser light beam for desired functions.

8. The laser light has optics parts as claim 4, the said laser light is parts of the said LED bulb so can has LED Bulb for illumination functions plus the said laser light functions.

9. The laser light has optics parts as claim 4, the said laser light has gear set to reduce the rotating speed of the said optics-piece or laser light source to change the laser light function under desired rotating per minute (RPM) or frequency (changing time during a period of time.

10. The laser light has optics parts as claim 4, the said laser light has timer to make the light show as preferred time, time period for turn-on and turn-off or performance cycles, times.

11. The laser light has optics parts as claim 4, the said laser light has at least one of brightness and color(s), timer, time setting controller.

12. The laser light has optics parts as claim 4, the said laser light has at least one color, or any number of colors.

13. The laser light has optics parts as claim 4, the said laser light source or laser unit has different power or wattage for output so can make laser light for wider range or remote distance, areas for light show to be seen.

14. The laser light has optics parts as claim 4, the said laser light's optics parts can be a film, plastic piece, injection piece, stamping, embossing, scratching piece, lens to fit on front side with desired distance to the laser light source output end(s).

15. The laser light has optics parts as claim 4, the said laser light has indicator light to present desired message including but not limited for laser light turn-on and turn-off status or warning sign.

16. The laser light has optics parts as claim 4, the said laser light or the said laser unit(s) turn-on or turn-off or change functions by controller, or sensor, or switch has wired or by wireless device.

17. The laser light has optics parts as claim 4, the said laser light or the said laser unit(s) will turn-off or has warning sound/siren while people close to the said laser light or laser unit(s) as safety device.

18. The laser light has optics parts as claim 4, the said laser light has safety device to prevent laser beam direct to into the people eye within the warning distance which may use motions sensor detector or other sensor device to turn-off the laser light or give warming sound/siren/alarm while people approach or within the pre-determined range and distance.

19. The laser light has optics parts as claim 4, the said laser light source incorporate with at least one of grating, hologram, optic-lens, texture optics-piece, reflective optics-piece, refraction optics-piece, or optics related film, lens, sheet, injection piece, glass piece, stencils, cutout, shaped windows, geometric patterns to create desired image, shape, geometric figure to wider areas for laser light beam.
